(19) United States
(12) Patent Application Publication
(10) Pub. No.: US 2006/0013312 A1
(43) Pub. Date: Jan. 19, 2006

(54) Method and apparatus for scalable video coding and decoding

(75) Inventor: Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/177,391

(22) Filed: Jul. 11, 2005

(30) Foreign Application Priority Data
Jul. 14, 2004 (KR) 10-2004-0054816

(51) Int. Cl. H04N 11/04; H04B 1/66; H04N 7/12; H04N 11/02

(52) U.S. Cl. 375/240.19; 375/240.03; 375/240.18

(57) ABSTRACT

A method and apparatus for video coding supporting spatial scalability by performing wavelet transform using filters with different coefficients according to wavelet decomposition levels are provided. The video coding method comprising removing temporal and spatial redundancies within a plurality of input frames, quantizing transform coefficients obtained by removing the temporal and spatial redundancies, and generating a bitstream using the quantized transform coefficients, wherein the spatial redundancies are removed using a plurality of wavelet kernels according to wavelet decomposition levels.

### CROSS-REFERENCE TO RELATED APPLICATION

This application claims priority from Korean Patent Application No. 10-2004-0054816 filed on Jul. 14, 2004 in the Korean Intellectual Property Office, the disclosure of which is incorporated herein by reference in its entirety.

### BACKGROUND OF THE INVENTION

1. Field of the Invention

Apparatuses and methods consistent with the present invention relate to video compression, and more particularly, to video coding supporting spatial scalability by performing wavelet transform using a filter with different coefficient at each level.

2. Description of the Related Art

With the development of information communication technology including the Internet, video communication as well as text and voice communication has rapidly increased. Conventional text communication cannot satisfy various user demands, and thus multimedia services that can provide various types of information such as text, pictures, and music have increased. Multimedia data requires a large capacity of storage media and a wide bandwidth for transmission since the amount of multimedia data is usually large in relative terms to other types of data. Accordingly, a compression coding method is required for transmitting multimedia data including text, video, and audio. For example, a 24-bit true color image having a resolution of 640*480 needs a capacity of 640*480*24 bits, i.e., data of about 7.37 Mbits, per frame. When an image such as this is transmitted at a speed of 30 frames per second, a bandwidth of 221 Mbits/sec is required. When a 90-minute movie based on such an image is stored, a storage space of about 1200 Gbits is required. Accordingly, a compression coding method is a requisite for transmitting multimedia data including text, video, and audio.

In such a compression coding method, a basic principle of data compression lies in removing data redundancy. Data redundancy is typically defined as spatial redundancy in which the same color or object is repeated in an image, temporal redundancy in which there is little change between adjacent frames in a moving image or the same sound is repeated in audio, or mental visual redundancy taking into account human eyesight and perception dull to high frequency. Data can be compressed by removing such data redundancy. Data compression can largely be classified into lossy/lossless compression, according to whether source data is lost, intraframe/interframe compression, according to whether individual frames are compressed independently, and symmetric/asymmetric compression, according to whether time required for compression is the same as time required for recovery. In addition, data compression is defined as real-time compression when a compression/recovery time delay does not exceed 50 ms and as scalable compression when frames have different resolutions. As examples, for text or medical data, lossless compression is usually used. For multimedia data, lossy compression is usually used. Meanwhile, intraframe compression is usually used to remove spatial redundancy, and interframe compression is usually used to remove temporal redundancy.

Transmission performance is different depending on transmission media. Currently used transmission media have various transmission rates. For example, an ultra high-speed communication network can transmit data of several tens of megabits per second while a mobile communication network has a transmission rate of 384 kilobits per second. In related art video coding methods such as Motion Picture Experts Group (MPEG)-1, MPEG-2, H.263, and H.264, temporal redundancy is removed by motion compensation based on motion estimation and compensation, and spatial redundancy is removed by transform coding. These methods have satisfactory compression rates, but they do not have the flexibility of a truly scalable bitstream since they use a reflexive approach in a main algorithm. Accordingly, in recent year, wavelet video coding has been actively researched. Scalability indicates the ability to partially decode a single compressed bitstream, that is, the ability to perform a variety of types of video reproduction. Scalability includes spatial scalability indicating a video resolution, signal-to-noise ratio (SNR) scalability indicating a video quality level, temporal scalability indicating a frame rate, and a combination thereof.

In scalable video coding, a wavelet transform is a representative technique to remove spatial redundancies. FIGS. 1A and 1B illustrate wavelet transform processes for scalable video coding.

Referring to FIG. 1A, each row of a frame is filtered with a low-pass filter Lx and a high-pass filter Hx and downsampled to generate intermediate images L and H. That is, the intermediate image L is the original frame low-pass filtered and downsampled in the x direction and the intermediate image H is the original frame high-pass filtered and downsampled in the x direction. Then, the respective columns of the L and H images are again filtered with a low-pass filter Ly and a high-pass filter Hy and downsampled by a factor of two to generate four subbands LL, LH, HL, and HH. The four subbands are combined together to generate a single resultant image having the same number of samples as the original frame. The LL image is the original frame low-pass filtered horizontally and vertically and downsampled by powers of two. The HL image is the original frame high-pass filtered vertically, low-pass filtered horizontally, and downsampled by powers of two.

As described above, in the wavelet transform, a frame is decomposed into four portions. A quarter-sized image (L subband) that is similar to the entire image appears in the upper left portion of the frame and information (H subband) needed to reconstruct the entire image from the L image appears in the other three portions. In the same way, the L subband may be decomposed into a quarter-sized LL subband and information needed to reconstruct the L image.

All wavelet-based video or image codecs achieve compression by performing spatial wavelet transform iteratively on a residual signal obtained from motion estimation or original signal using the same wavelet filter in order to remove spatial redundancies, followed by quantization. There are various wavelet transform methods according to the type of a wavelet filter used. Wavelet filters such as Haar, 5/3, 9/7, and 11/13 filters have different characteristics according to the number of coefficients. Coefficients determining the characteristics of a wavelet filter such as Haar, 5/3, 9/7, or 11/13 are called a wavelet kernel. Most wavelet-based video/image codecs use a 9/7 wavelet filter known to exhibit excellent performance.

A low-resolution signal obtained from a 9/7 filter contains excessive high frequency components representing fine texture regions almost invisible to the naked eye, thus degrading the compression performance of a codec. On the other hand, reducing energy in texture information corresponding to a low-pass band results in compaction of energy in a high-pass band, thereby degrading the performance of wavelet-based compression intended to increase a compression ratio by concentrating most of energy in a low-pass band. The performance degradation occurs more severely at a low resolution.

To address the above problems, there is a need for a video coding algorithm designed to improve the performance at a low resolution while not significantly decreasing the performance at a high resolution.

### SUMMARY OF THE INVENTION

The present invention provides a method and apparatus for scalable video coding and decoding that deliver improved performance by performing wavelet transform using a different wavelet filter for each level according to the resolution or complexity of an input video or image.

According to an aspect of the present invention, there is provided a video coding method comprising removing temporal and spatial redundancies within a plurality of input frames, quantizing transform coefficients obtained by removing the temporal and spatial redundancies, and generating a bitstream using the quantized transform coefficients, wherein the spatial redundancies are removed by wavelet transform applying a plurality of wavelet kernels according to wavelet decomposition levels.

According to another aspect of the present invention, there is provided a video encoder comprising a temporal transformer that receives a plurality of frames and removes temporal redundancies within the plurality of frames, a spatial transformer that removes spatial redundancies by performing wavelet transform using a plurality of wavelet kernels according to wavelet decomposition levels, a quantizer that quantizes transform coefficients obtained by removing the temporal and spatial redundancies, and a bitstream generator that generates a bitstream using the quantized transform coefficients.

According to still another aspect of the present invention, there is provided a video decoding method comprising interpreting a received bitstream and extracting information about coded frames, inversely quantizing the information about the coded frames and obtaining transform coefficients, performing inverse spatial transform and inverse temporal transform in an order reverse to an order in which redundancies within the coded frames are removed and reconstructing the coded frames, wherein the inverse spatial transform is inverse wavelet transform that is performed on the transform coefficients using a plurality of wavelet kernels according to wavelet decomposition levels in an order reverse to an order in which the plurality of wavelet kernels are applied.

According to a further aspect of the present invention, there is provided a video decoder comprising a bitstream interpreter that interprets a received bitstream and extracts information about coded frames, an inverse quantizer that inversely quantizes the information about the coded frames into transform coefficients, an inverse spatial transformer that performs inverse wavelet transform on the transform coefficients using a plurality of wavelet kernels according to wavelet decomposition levels in an order reverse to an order in which the plurality of wavelet kernels are applied, and an inverse temporal transformer that performs inverse temporal transform, wherein the inverse spatial transform and the inverse temporal transform are performed on the transform coefficients in an order reverse to an order in which redundancies within frames are removed.

### BRIEF DESCRIPTION OF THE DRAWINGS

The above and other aspects of the present invention will become more apparent by describing in detail exemplary embodiments thereof with reference to the attached drawings in which:

FIGS. 1A and 1B illustrate wavelet transform processes for scalable video coding;

FIG. 2 illustrates a temporal decomposition process in scalable video coding and decoding based on Motion Compensated Temporal Filtering (MCTF);

FIG. 3 illustrates a temporal decomposition process in scalable video coding and decoding based on Unconstrained MCTF (UMCTF);

FIG. 4 is a block diagram of a scalable video encoder according to a first exemplary embodiment of the present invention;

FIG. 5 is a block diagram of a scalable video encoder according to a second exemplary embodiment of the present invention;

FIG. 6 is a detailed block diagram of the spatial transformer shown in FIG. 4 or 5 according to an exemplary embodiment of the present invention;

FIG. 7 illustrates a multi-kernel wavelet transform process according to an exemplary embodiment of the present invention;

FIG. 8 is a flowchart illustrating a scalable video encoding process according to a first exemplary embodiment of the present invention;

FIG. 9 is a flowchart illustrating a scalable video encoding process according to a second exemplary embodiment of the present invention;

FIG. 10 is a block diagram of a scalable video decoder according to an exemplary embodiment of the present invention; and

FIG. 11 is a flowchart illustrating a scalable video decoding process according to an exemplary embodiment of the present invention.

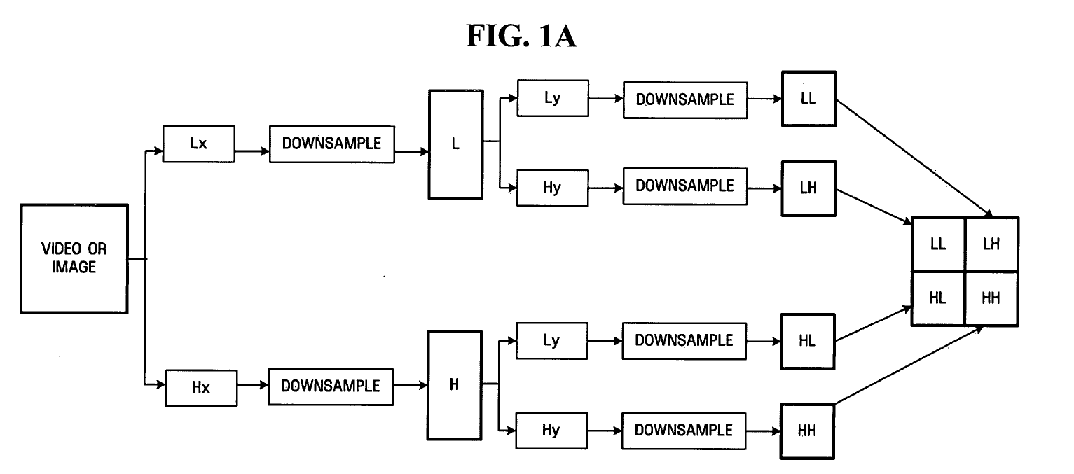

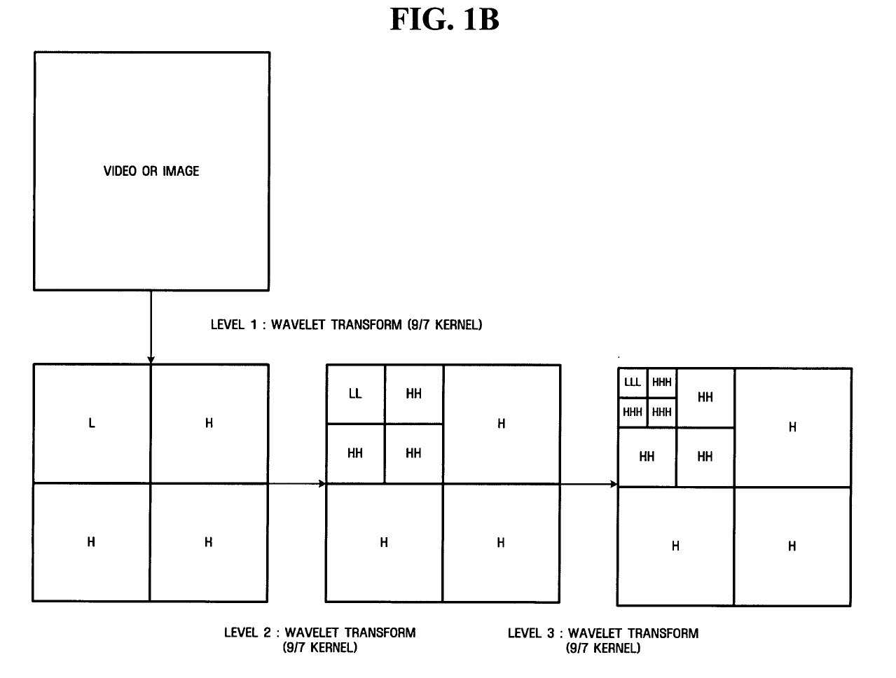

### DETAILED DESCRIPTION OF EXEMPLARY EMBODIMENTS OF THE INVENTION

The present invention will now be described more fully with reference to the accompanying drawings, in which exemplary embodiments of the invention are shown.

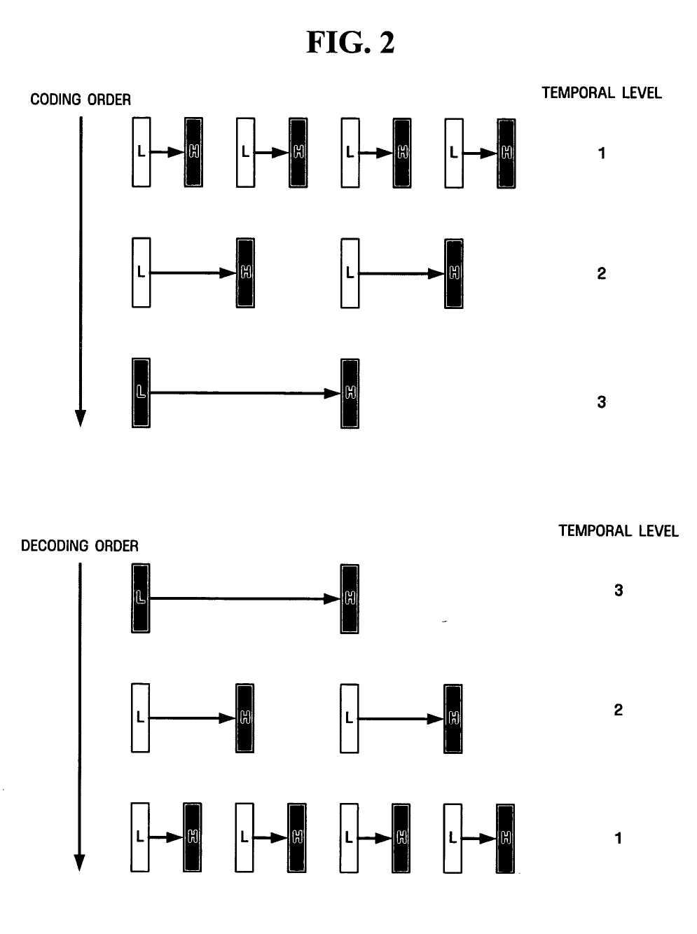

FIG. 2 illustrates a temporal decomposition process in scalable video coding and decoding based on Motion Compensated Temporal Filtering (MCTF).

Referring to FIG. 2, in MCTF, coding is performed on each group of pictures (GOP), and a pair of current frame and reference frame are temporally filtered in the direction of motion.

Among many techniques used for wavelet-based scalable video coding, MCTF that was introduced by Ohm and improved by Choi and Wood is an essential technique for removing temporal redundancy and for video coding having flexible temporal scalability. In MCTF, coding is performed on a GOP and a pair of a current frame and a reference frame are temporally filtered in a motion direction.

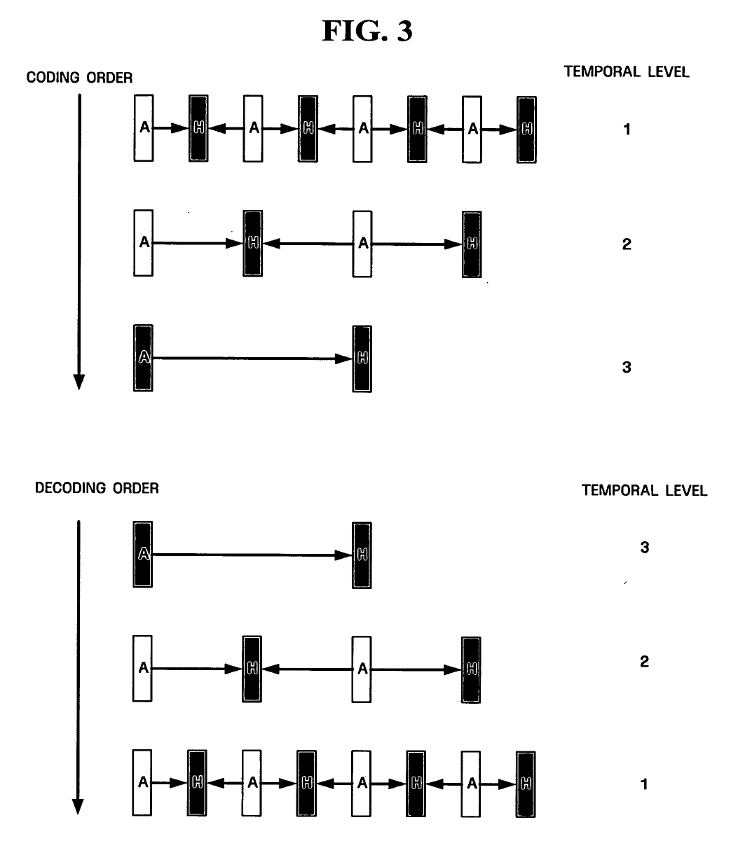

In FIG. 2, an L frame is a low frequency frame corresponding to an average of frames while an H frame is a high frequency frame corresponding to a difference between frames. As shown in FIG. 2, in a coding process, pairs of frames at a low temporal level are temporally filtered and then decomposed into pairs of L frames and H frames at a higher temporal level, and the pairs of L frames are again temporally filtered and decomposed into frames at a higher temporal level. An encoder performs wavelet transformation on one L frame at the highest temporal level and the H frames and generates a bitstream. Frames indicated by shading in the drawing are ones that are subjected to a wavelet transform. More specifically, the encoder encodes frames from a low temporal level to a high temporal level. Meanwhile, a decoder performs an inverse operation to the encoder on the frames indicated by shading and obtained by inverse wavelet transformation from a high level to a low level for reconstruction. That is, L and H frames at temporal level 3 are used to reconstruct two L frames at temporal level 2, and the two L frames and two H frames at temporal level 2 are used to reconstruct four L frames at temporal level 1. Finally, the four L frames and four H frames at temporal level 1 are used to reconstruct eight frames. Such MCTF-based video coding has an advantage of improved flexible temporal scalability but has disadvantages such as unidirectional motion estimation and bad performance in a low temporal rate. Many approaches have been researched and developed to overcome these disadvantages. One of them is unconstrained MCTF (UMCTF) proposed by Turaga and Mihaela, which will be described with reference to FIG. 3.

FIG. 3 schematically illustrates temporal decomposition during scalable video coding and decoding using UMCTF.

UMCTF allows a plurality of reference frames and bi-directional filtering to be used and thereby provides a more generic framework. In addition, in a UMCTF scheme, nondichotomous temporal filtering is feasible by appropriately inserting an unfiltered frame, i.e., an A-frame. UMCTF uses A-frames instead of filtered L-frames, thereby remarkably increasing the quality of pictures at a low temporal level. This is because visual quality of L frames may often be significantly degraded due to inaccurate motion estimation. Since many experimental results show UMCTF without a frame update operation provides better performance than MCTF, a specific form of UMCTF without an update operation is more commonly used than the most general form of UMCTF adaptively selecting a low-pass filter.

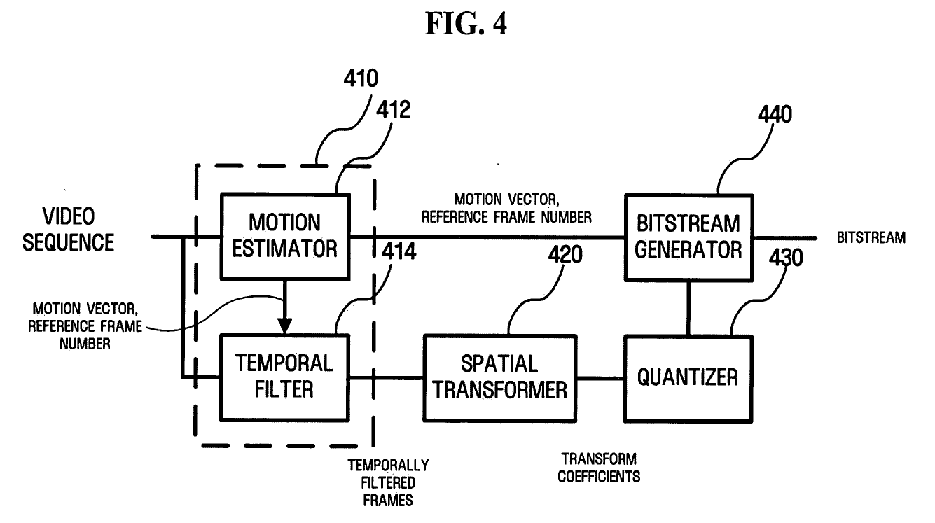

FIG. 4 is a block diagram of a scalable video encoder according to a first exemplary embodiment of the present invention.

The scalable video encoder receives a plurality of frames in a video sequence, compresses the frames on a GOP-by-GOP basis, and generates a bitstream. To accomplish this, the scalable video encoder includes a temporal transformer 410 removing temporal redundancies that exist within a plurality of frames, a spatial transformer 420 removing spatial redundancies, a quantizer 430 quantizing transform coefficients generated by removing the temporal and spatial redundancies, and a bitstream generator 440 generating a bitstream containing the resulting quantized transform coefficients and other information.

The temporal transformer 410 includes a motion estimator 412 and a temporal filter 414 in order to perform temporal filtering by compensating for motion between frames. The motion estimator 412 calculates a motion vector between each block in a current frame being subjected to temporal filtering and its counterpart in a reference frame. The temporal filter 414 that receives information about the motion vectors performs temporal filtering on the plurality of frames using the information.

The spatial transformer 420 uses a wavelet transform to remove spatial redundancies from the frames from which the temporal redundancies have been removed, i.e., temporally filtered frames. As described above, in the wavelet transform, a frame is decomposed into four portions. A quarter-sized image (L subband) that is similar to the entire image appears in the upper left portion of the frame and information (H subband) needed to reconstruct the entire image from the L image appears in the other three portions. In the same way, the L subband may be decomposed into a quarter-sized LL subband and information needed to reconstruct the L image.

In the present exemplary embodiment, when the wavelet transform is performed iteratively at many wavelet decomposition levels, a plurality of wavelet kernels may be used according to wavelet decomposition levels. In this specification, applying a plurality of wavelet kernels according to wavelet decomposition levels includes a case of applying different wavelet kernels at more than two levels among a plurality of levels, as well as a case of applying a different wavelet kernel at each level. For example, the wavelet transform may be performed using kernels A, B, and C at levels 1, 2, and 3, respectively. Alternatively, kernel A may be used at level 1 while kernel B may be used at levels 2 and 3. Otherwise, the same kernel A may be applied at levels 1 and 2 while kernel B may be applied at level 3.

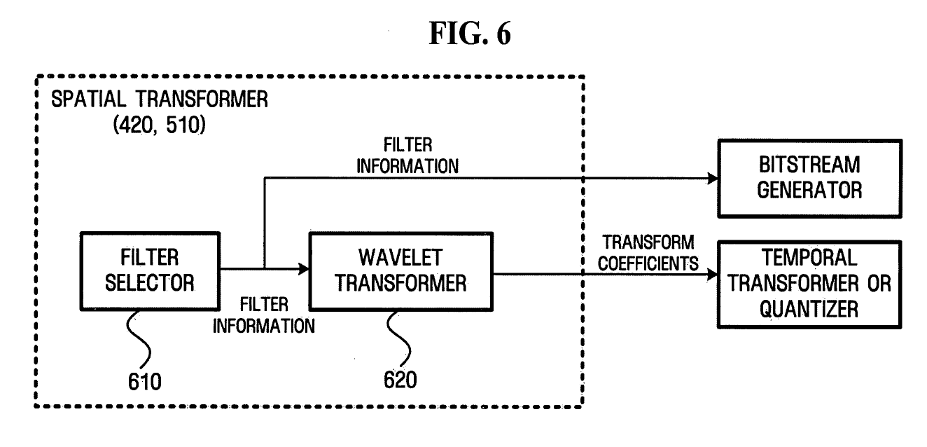

A video encoder may contain a function of selecting a wavelet kernel that will be used at each level, which will be described in detail later with reference to FIG. 6. Alternatively, a wavelet kernel may be selected by a user.

The temporally filtered frames are spatially transformed into transform coefficients that are then sent to the quantizer 430 for quantization. The quantizer 430 converts the real transform coefficients into integer transform coefficients. An MCTF-based video encoder uses embedded quantization. By performing embedded quantization on transform coefficients, the scalable video encoder can reduce the amount of information to be transmitted and achieve signal-to-noise ratio (SNR) scalability. Embedded quantization algorithms currently in use are Embedded Zerotree Wavelet (EZW), Set Partitioning in Hierarchical Trees (SPIHT), Embedded Zero Block Coding (EZBC), and Embedded Block Coding with Optimized Truncation (EBCOT).

The bitstream generator 440 generates a bitstream containing coded image data, the motion vectors obtained from the motion estimator 412, and other necessary information.

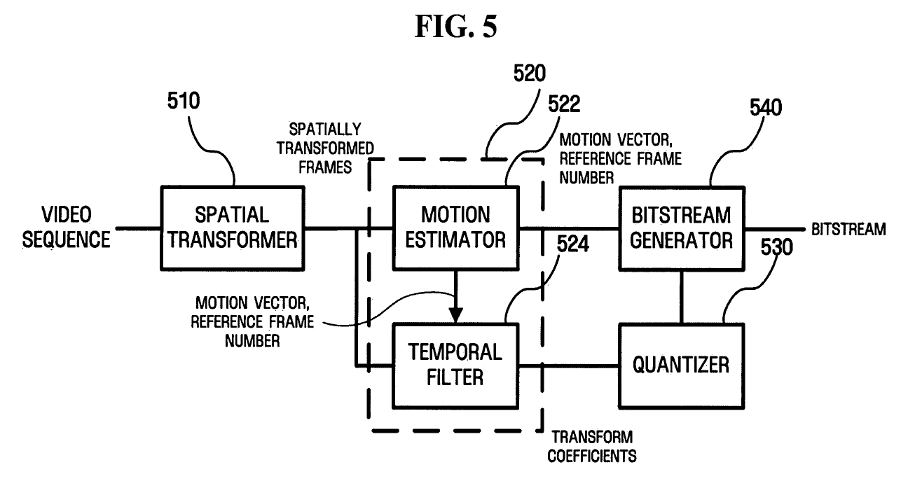

The scalable video coding method includes a method of performing a spatial transform (i.e., a wavelet transform) on frames and then performing a temporal transform, which is called an in-band scalable video coding, which is described with reference to FIG. 5.

FIG. 5 is a block diagram of a scalable video encoder according to a second exemplary embodiment of the present invention.

An in-band scalable video encoder is designed to remove temporal redundancies that exist within a plurality of frames making up a video sequence after removing spatial redundancies.

Referring to FIG. 5, a spatial transformer 510 performs wavelet transform on each frame to remove spatial redundancies that exist within frames.

A temporal transformer 520 includes a motion estimator 522 and a temporal filter 524 and performs temporal filtering on the frames from which the spatial redundancies have been removed in a wavelet domain in order to remove temporal redundancies.

A quantizer 530 applies quantization to transform coefficients obtained by removing spatial and temporal redundancies within the frames. A bitstream generator 540 combines motion vectors and coded image subjected to quantization into a bitstream.

FIG. 6 is a detailed block diagram of the spatial transformer (420 or 510 shown in FIG. 4 or 5) according to an exemplary embodiment of the present invention.

When performing a wavelet transform using a plurality of wavelet kernels according to wavelet decomposition levels, the spatial transformer 420 or 510 selects a filter that will be used at each level. In the exemplary embodiment, a filter selector 610 of the spatial transformer 420 or 510 selects a suitable wavelet filter according to the complexity or resolution of an input video or image and sends information about the selected filter to a wavelet transformer 620 and the bitstream generator 440 or 540. Since representation of detailed texture information is essential in the case of an input video having high complexity or resolution, a kernel providing good energy compaction in a low-pass band instead of smoothing a low-pass band is selected at a low level. A kernel producing a smoother low-pass band may be used at higher levels to effectively reduce fine texture information.

For example, while a conventional 9/7 filter is used at level 1, a kernel with a larger number of coefficients such as 11/13 and 13/15 or a kernel designed to provide a smoother low-pass band than the 9/7 filter by a user may be used at a lower resolution level.

The wavelet transformer 620 performs wavelet transform with the wavelet filter selected by the filter selector 610 at each level according to the received filter information and provides transform coefficients created by the wavelet transform to the transformer 520 or the quantizer 430.

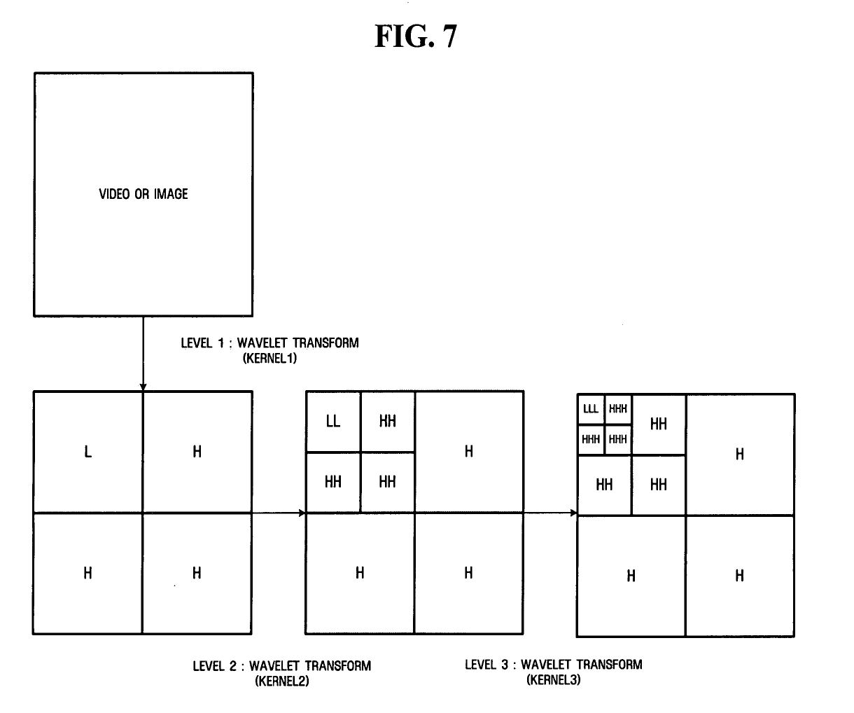

FIG. 7 illustrates a multi-kernel wavelet transform process according to an exemplary embodiment of the present invention.

A smoothing wavelet kernel reducing texture information in a low-pass band may be used at a higher level. For example, a conventional 9/7 filter, an 11/13 filter, and a 13/15 filter may be used as kernel 1, kernel 2, and kernel 3, respectively. While the degree of smoothing in a low-pass band increases as the number of coefficients in a filter increases, the degree of smoothing may vary depending on an algorithm or values of transform coefficients even when a filter having the same number of coefficients is used. Thus, in the present invention, coefficients representing a kernel do not absolutely determine the degree of smoothing in a low-pass band.

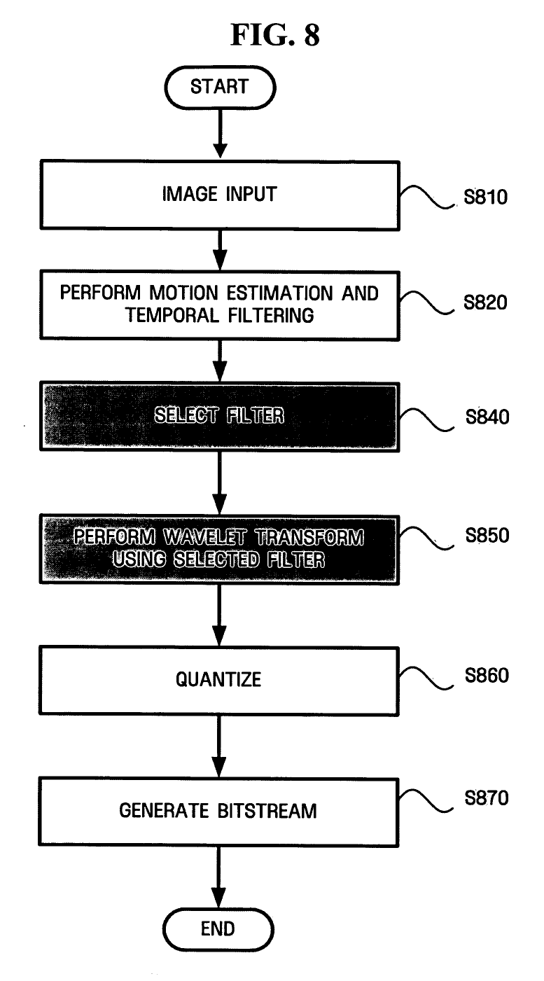

FIG. 8 is a flowchart illustrating a scalable video encoding process according to a first exemplary embodiment of the present invention.

Referring to FIG. 8, when a video or an image is input in operation S810, motion estimation and temporal filtering are sequentially performed on frames in the input video or image by the motion estimator (412 of FIG. 4) and the temporal filter (414 of FIG. 4), respectively, in operation S820. In operation S850, the temporally filtered frames are subjected to wavelet transform using a wavelet filter selected in operation S840. Transform coefficients generated by the wavelet transform is quantized in operation S860 and then encoded into a bitstream in operation S870.

In operation S840, the wavelet filter may be selected by a user or the filter selector (610 of FIG. 6) in the scalable video encoder. In operation S870, a bitstream containing information about a wavelet kernel provided by the user or the filter selector is generated. Alternatively, when information about the wavelet kernel to be used at each level is shared between an encoder and a decoder, the information may not be contained in the bitstream.

Meanwhile, when the scalable video encoding process is performed by the encoder shown in FIG. 5, the filtering selection (operation S840) and wavelet transform (operation S850) are followed by the motion estimation and temporal filtering (operation S820).

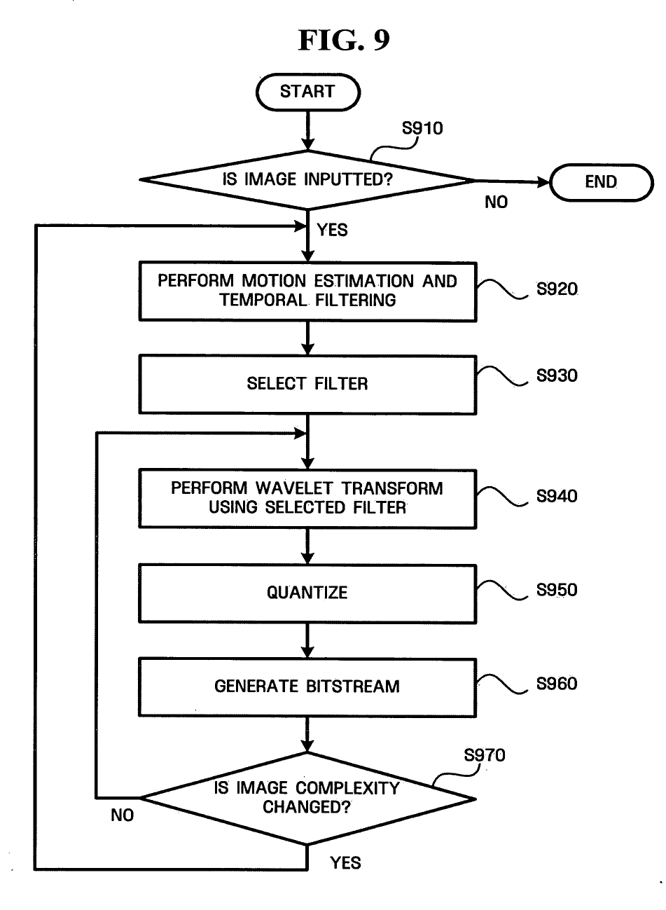

FIG. 9 is a flowchart illustrating a scalable video encoding process according to a second exemplary embodiment of the present invention.

Operations of the scalable video encoding process of FIG. 9 are performed in the same order as the operations in FIG. 8. That is, when an image is input in operation S910, motion estimation and temporal filtering (operation S920), selection of a filter (operation S930), and wavelet transform using the selected wavelet filter (operation S940) are performed sequentially.

In the scalable video encoding process shown in FIG. 8, when a wavelet kernel to be used at each level of wavelet transform is selected for each video sequence, wavelet transform is performed using the same wavelet kernels until the end of the video sequence. However, the scalable video encoding process according to the present exemplary embodiment further includes adaptively changing a filter (operation S970) when a change in complexity or resolution of an image occurs during encoding of a video sequence. For a video sequence having dynamically changing complexity or resolution, a set of wavelet kernels to be used at each level may be changed on a GOP-by-GOP or scene-by-scene basis.

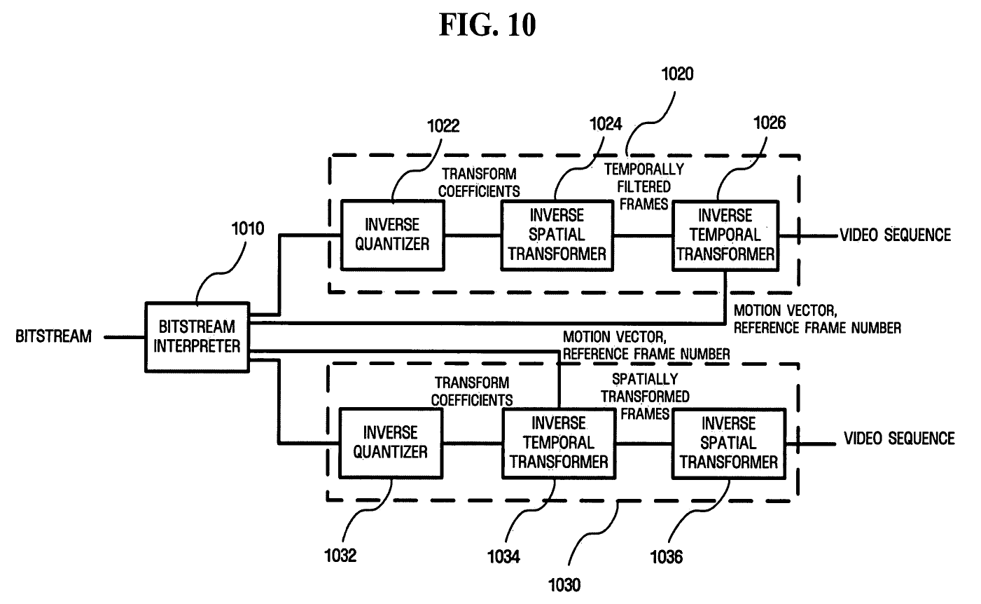

FIG. 10 is a block diagram of a scalable video decoder according to an exemplary embodiment of the present invention.

The scalable video decoder includes a bitstream interpreter 1010 interpreting a received bitstream and extracting each part from the received bitstream, a first decoding unit 1020 reconstructing an image encoded by the scalable video encoder shown in FIG. 4, and a second decoding unit 1030 reconstructing an image encoded by the scalable video encoder shown in FIG. 5.

The first and second decoding units 1020 and 1030 may be realized by a hardware or software module. In this case, the first and second decoding units 1020 and 1030 may be separated from each other as shown in FIG. 10 or integrated into a single module. When the first and second decoding units 1020 and 1030 are integrated into a single module, the first and second decoding units 1020 and 1030 perform inverse redundancy removal in different orders determined by the bitstream interpreter 1010.

While the scalable video decoder reconstructs all images encoded according to different redundancy removal orders as shown in FIG. 10, it may be designed to reconstruct only images encoded according to one redundancy removal order.

The bitstream interpreter 1010 interprets an input bitstream, extracts coded image data (coded frames), and determines the order of redundancy removal. When temporal redundancies are removed, and then spatial redundancies are removed within a video sequence, the video sequence is reconstructed through the first decoding unit 1020. On the other hand, when spatial redundancies are removed, and then temporal redundancies are removed within a video sequence, the video sequence is decoded through the second decoding unit 1030. Further, the bitstream interpreter 1010 interprets a bitstream to obtain information about a plurality of wavelet filters used at the respective levels during wavelet transform. When the information about wavelet filters is shared between the encoder and the decoder, it may not be contained in the bitstream. A process of reconstructing a video sequence in the first and second decoding units 1020 and 1030 will now be described.

Coded frame information input to the first decoding unit 1020 is inversely quantized by an inverse quantizer 1022 into transform coefficients that is then subjected to inverse wavelet transform by an inverse spatial transformer 1024. The inverse wavelet transform is performed using an inverse wavelet filter in an order reverse to an order in which a wavelet filter is used at each level. An inverse temporal transformer 1026 performs inverse temporal transform on the transform coefficients subjected to the inverse wavelet transform using motion vectors obtained by interpreting the input bitstream and reconstructs frames making up a video sequence.

On the other hand, coded frame information input to the second decoding unit 1030 is inversely quantized by an inverse quantizer 1022 into transform coefficients that is then subjected to inverse temporal transform by an inverse temporal transformer 1034. The coded frame information subjected to the inverse temporal transform is converted into spatially transformed frames. An inverse spatial transformer 1036 applies inverse spatial transform to the spatially transformed frames and reconstructs frames making up a video sequence. Information about a plurality of wavelet kernels needed for the inverse spatial transform may be obtained from the bitstream interpreter 1010 or shared between the encoder and the decoder. Inverse wavelet transform is used for inverse spatial transform.

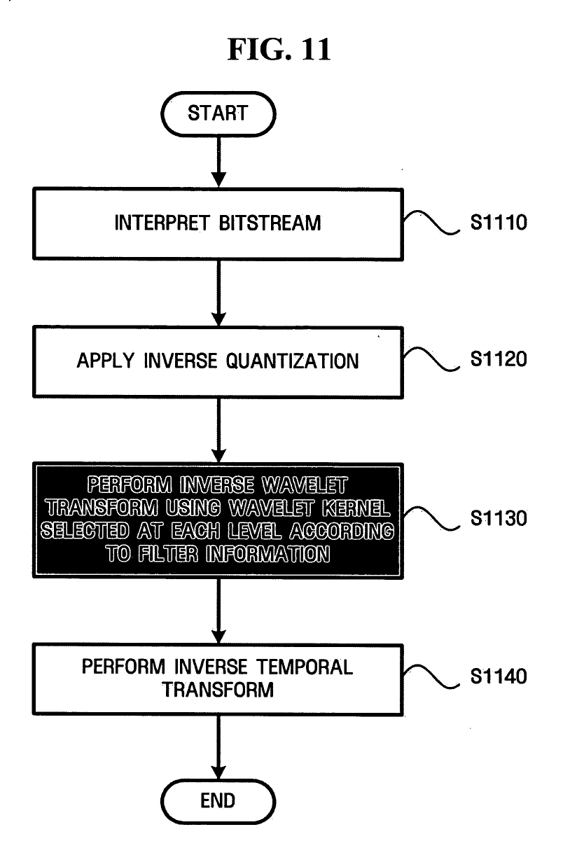

FIG. 11 is a flowchart illustrating a scalable video decoding process according to an exemplary embodiment of the present invention.

A decoding process in the first decoding unit (1020 of FIG. 10) includes interpreting a bitstream (operation S1110), inversely quantizing coded frame information (operation S1120), performing inverse wavelet transform using a filter according to filter information (operation S1130), and performing inverse temporal transform (operation S1140). On the other hand, operations of a decoding process in the second decoding unit (1030 of FIG. 10) are performed in a different order than the operations of the decoding process in the first decoding unit (1020 of FIG. 10). In particular, the decoding process in the second decoding unit (1030 of FIG. 10) includes interpreting a bitstream (operation S1110), inversely quantizing coded frame information (operation S1120), performing inverse temporal transform (operation S1140), and performing inverse wavelet transform using a filter according to filter information (operation S1130).

In operation S1110, a bitstream is interpreted by the bitstream interpreter (1010 of FIG. 10) in order to extract information about a wavelet kernel used at each level. When the information about a wavelet kernel is shared between an encoder and a decoder, the extraction operation may be omitted.

In operation S1130, the inverse wavelet transform is performed using an inverse wavelet filter according to an order reverse to an order in which a wavelet kernel is applied at each level during wavelet transform. As described above, the order is determined according to the information extracted from the bitstream or shared between the encoder and the decoder.

According to the present invention, video coding with improved performance at low resolution can be achieved using a different wavelet kernel at each level during wavelet transform.

While it is described above that a wavelet transform method employing a plurality of different wavelet kernels, i.e., using a different wavelet filter at each level is applied to video coding and decoding supporting both temporal and spatial scalabilities, it will be readily apparent to those of ordinary skill in the art that the wavelet transform is applied to video (image) coding and decoding supporting only spatial scalability.

It will be understood by those of ordinary skill in the art that various changes in form and details may be made therein without departing from the spirit and scope of the present invention as defined by the following claims. Therefore, it is to be appreciated that the above described exemplary embodiments are for purposes of illustration only and not to be construed as a limitation of the invention. The scope of the invention is given by the appended claims, rather than the preceding description, and all variations and equivalents which fall within the range of the claims are intended to be embraced therein.

What is claimed is:

1. A video encoding method comprising:
removing temporal and spatial redundancies within a plurality of frames;
quantizing transform coefficients obtained by removing the temporal and spatial redundancies; and
generating a bitstream using the transform coefficients which are quantized,
wherein the spatial redundancies are removed by performing a wavelet transform using a plurality of wavelet kernels according to wavelet decomposition levels.

2. The method of claim 1, wherein the bitstream contains information about the plurality of wavelet kernels.

3. The method of claim 1, wherein the plurality of wavelet kernels vary depending on a state of the frames.

4. The method of claim 3, wherein the state of the frames is at least one of complexity and resolution of the frames.

5. The method of claim 1, wherein the plurality of wavelet kernels produce a smoother low-pass band at higher levels.

6. The method of claim 1, wherein the plurality of wavelet kernels include a 9/7 kernel at level 1, at least one of a 11/13 kernel at level 2 and a 13/15 kernel at level 2, and a kernel at level 3 producing a low-pass band which is equally smooth or smoother than a low-pass band produced by the kernel at level 2.

7. The method of claim 1, wherein the plurality of wavelet kernels are adaptively changed based on at least one of a group of pictures basis and a scene basis depending on a state of the frames.

8. A video encoder comprising:
a temporal transformer that receives a plurality of frames and removes temporal redundancies within the plurality of frames;
a spatial transformer that removes spatial redundancies by performing a wavelet transform using a plurality of wavelet kernels according to wavelet decomposition levels;
a quantizer that quantizes transform coefficients obtained by removing the temporal and spatial redundancies; and
a bitstream generator that generates a bitstream using the transform coefficients which are quantized.

9. The video encoder of claim 8, wherein the temporal transformer provides the frames from which the temporal redundancies have been removed to the spatial transformer that then removes the spatial redundancies within the frames and obtains the transform coefficients.

10. The video encoder of claim 8, wherein the spatial transformer provides the frames from which the spatial redundancies have been removed using the wavelet transform to the temporal transformer that then removes the temporal redundancies within the frames and obtains the transform coefficients.

11. The video encoder of claim 8, wherein the spatial transformer comprises:
a filter selector that selects the plurality of wavelet kernels according to the wavelet decomposition levels; and
a wavelet transformer that performs the wavelet transform using the plurality of wavelet kernels which are selected.

12. The video encoder of claim 8, wherein the plurality of wavelet kernels vary depending on a state of the frames.

13. The video encoder of claim 12, wherein the state of the frames is at least one of a complexity of the frames and a resolution of the frames.

14. The video encoder of claim 12, wherein the bitstream contains information about the plurality of wavelet kernels.

15. The video encoder of claim 8, wherein the plurality of wavelet kernels produce a smoother low-pass band at higher levels.

16. The video encoder of claim 8, wherein the plurality of wavelet kernels include a 9/7 kernel at level 1, at least one of a 11/13 kernel at level 2 and a 13/15 kernel at level 2, and a kernel at level 3 producing a low-pass band which is equally smooth or smoother than a low-pass band produced by the kernel at level 2.

17. The video encoder of claim 8, wherein the plurality of wavelet kernels are adaptively changed based on at least one of a group of pictures basis and a scene basis depending on the state of the frames.

18. A video decoding method comprising:
interpreting a bitstream and extracting information about coded frames;
inversely quantizing the information about the coded frames and obtaining transform coefficients;
performing an inverse spatial transform and an inverse temporal transform in an order reverse to an order in which redundancies within the coded frames are removed, and reconstructing the coded frames,
wherein the inverse spatial transform is an inverse wavelet transform that is performed on the transform coefficients using a plurality of wavelet kernels according to wavelet decomposition levels in an order reverse to an order in which the plurality of wavelet kernels are applied.

19. The method of claim 18, wherein the performing the inverse spatial transform and the inverse temporal transform comprises performing the inverse temporal transform frames obtained from the transform coefficients, followed by the inverse spatial transform.

20. The method of claim 18, wherein performing the inverse spatial transform and the inverse temporal transform comprises performing the inverse spatial transform frames obtained from the transform coefficients, followed by the inverse temporal transform.

21. The method of claim 18, wherein the bitstream contains information about the plurality of wavelet kernels.

22. The method of claim 18, wherein the plurality of wavelet kernels produce a smoother low-pass band at higher levels.

23. A video decoder comprising:
a bitstream interpreter that interprets a bitstream and extracts information about coded frames;
an inverse quantizer that inversely quantizes the information about the coded frames into transform coefficients;
an inverse spatial transformer that performs an inverse wavelet transform on the transform coefficients using a plurality of wavelet kernels according to wavelet decomposition levels in an order reverse to an order in which the plurality of wavelet kernels are applied; and
an inverse temporal transformer that performs an inverse temporal transform,
wherein the inverse spatial transform and the inverse temporal transform are performed on the transform coefficients in an order reverse to an order in which redundancies within frames are removed.

24. The video decoder of claim 23, wherein the transform coefficients are subjected to the inverse temporal transform, followed by the inverse spatial transform.

25. The video decoder of claim 23, wherein the transform coefficients are subjected to the inverse spatial transform, followed by the inverse temporal transform.

26. The video decoder of claim 23, wherein the bitstream contains information about the plurality of wavelet kernels.

27. The video decoder of claim 23, wherein the plurality of wavelet kernels produce a smoother low-pass band at higher levels.

28. A recording medium having a computer readable program recorded therein, the program for executing a video encoding method, the method comprising:
removing temporal and spatial redundancies within a plurality of frames;
quantizing transform coefficients obtained by removing the temporal and spatial redundancies; and
generating a bitstream using the transform coefficients which are quantized,
wherein the spatial redundancies are removed by performing a wavelet transform using a plurality of wavelet kernels according to wavelet decomposition levels.

29. A recording medium having a computer readable program recorded therein, the program for executing a video decoding method, the method comprising:
interpreting a bitstream and extracting information about coded frames;
inversely quantizing the information about the coded frames and obtaining transform coefficients;
performing inverse spatial transform and inverse temporal transform in an order reverse to an order in which redundancies within the coded frames are removed, and reconstructing the coded frames,
wherein the inverse spatial transform is an inverse wavelet transform that is performed on the transform coefficients using a plurality of wavelet kernels according to wavelet decomposition levels in an order reverse to an order in which the plurality of wavelet kernels are applied.
